(19) United States
(12) Patent Application Publication
(10) Pub. No.: US 2009/0003838 A1
(43) Pub. Date: Jan. 1, 2009

(54) Optical Data Communication System Having Reduced Pulse Distortion and Method of Operating the Same

(75) Inventors: Young-Kai Chen, Berkeley Heights, NJ (US); Andreas B. Leven, Gillette, NJ (US)

Correspondence Address: HITT GAINES, PC;ALCATEL-LUCENT, PO BOX 832570, RICHARDSON, TX, 75083, US

(73) Assignee: Lucent Technologies Incorporated, Murray Hill, NJ (US)

(21) Appl. No.: 11/769,339

(22) Filed: Jun. 27, 2007

(51) Int. Cl. H04B 10/00

(52) U.S. Cl. 398/161; 398/140

(57) ABSTRACT

An optical data transmission system and a method of communicating data. In one embodiment, the transmission system is part of an optical data communication system that includes: (1) an optical pulse transmitter configured to generate amplitude-modulated optical pulses at a fixed repetition rate, (2) an optical filter coupled to an output of the optical pulse transmitter, having a transmission notch at the fixed repetition rate and configured to filter the optical pulses and (3) an optical detector coupled to an output of the optical filter and configured to produce an output electrical signal representative of intensities of the optical pulses provided by the optical filter.

### GOVERNMENT CONTRACT

The U.S. Government has a paid-up license in the invention and the right, in limited circumstances, to require the patent owner to license others on reasonable terms as provided for by the terms of Contract No. HR011-05-C-0153 awarded by DARPA.

### TECHNICAL FIELD OF THE INVENTION

The invention is directed, in general, to optical data communication systems and, more particularly, to an optical data communication system having a reduced pulse distortion and a method of operating the same to effect optical communication.

### BACKGROUND OF THE INVENTION

Optical communication systems, particularly including systems that employ optical fibers as their transmission medium, are finding wide use in a variety of modern communication applications. Some optical communication systems employ a stream of optical pulses to transmit data. The stream carries the data as an amplitude modulation on the pulses. Data rates achieved with such optical communication systems are very high, perhaps on the order of 10 to 40 gigabits per second (GBit/s). Despite the data rates achievable with modern optical communication systems, higher data rates remain advantageous. One of the challenges encountered with increasing data rates is optical pulse distortion. What is needed in the art is an optical data communication system having a reduced pulse distortion. What is also needed in the art is a method of communicating data with optical pulses in which the pulses exhibit a reduced distortion.

### SUMMARY OF THE INVENTION

To address the above-discussed deficiencies of the prior art, the invention provides, in one aspect, an optical data transmission system. In one embodiment, the transmission system is part of an optical data communication system that includes: (1) an optical pulse transmitter configured to generate optical pulses at a fixed repetition rate, (2) an optical filter coupled to an output of the optical pulse transmitter, having a transmission notch at the fixed repetition rate and configured to filter the optical pulses and (3) an optical detector coupled to an output of the optical filter and configured to produce an output electrical signal representative of intensities of the optical pulses provided by the optical filter.

Another aspect of the invention provides a method of transmitting data. In one embodiment, the method includes: (1) generating a stream of optical pulses and (2) passing the stream of optical pulses through an optical filter, the optical pulses being at a fixed repetition rate, the optical filter having a transmission notch at the fixed repetition rate and a transmission notch at a first harmonic of the fixed repetition rate.

Yet another aspect of the invention provides an optical data transmission system. In one embodiment, the transmission system includes: (1) an optical pulse transmitter configured to generate optical pulses at a fixed repetition rate and (2) an optical filter coupled to an output of the optical pulse transmitter, having a transmission notch at the fixed repetition rate and configured to filter the optical pulses.

The foregoing has outlined aspects and embodiments of the invention so that those skilled in the pertinent art may better understand the detailed description that follows. Additional and alternative features will be described hereinafter that form the subject of the claims of the invention. Those skilled in the pertinent art should appreciate that they can readily use the disclosed conception and specific embodiment as a basis for designing or modifying other structures for carrying out the same purposes. Those skilled in the pertinent art should also realize that such equivalent constructions lie within the scope of the invention.

### BRIEF DESCRIPTION OF THE DRAWINGS

For a more complete understanding, reference is now made to the following descriptions taken in conjunction with the accompanying drawings, in which:

FIG. 1 illustrates a block diagram of an optical data communication system incorporating an optical data transmission system and including an optical filter, all being constructed according to the principles of the invention;

FIG. 2 illustrates a graphical representation of a representative characteristic of one embodiment of the optical filter of FIG. 1; and

FIG. 3 illustrates a flow diagram of one embodiment of a method of communicating data carried out according to the principles of the invention.

### DETAILED DESCRIPTION

It has been discovered that as the regular repetition rate of a stream of optical pulses is increased (the pulses occur ever closer to one another), interactions among adjacent pulses increase, creating not only a optical wave having a fundamental frequency equal to the repetition rate but odd and even harmonics of that optical wave. This optical wave can interfere with the stream of optical pulses and degrade system performance. It is therefore desirable to filter out the optical wave and perhaps at least some of its harmonics.

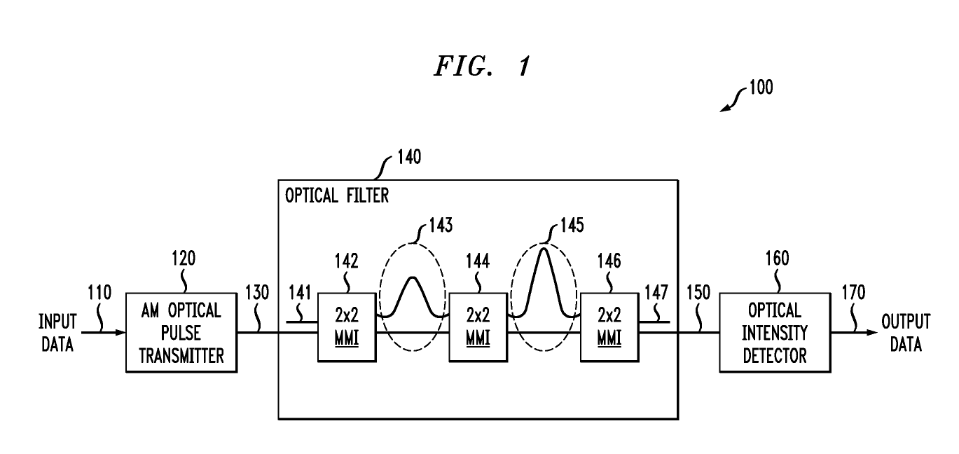

FIG. 1 illustrates a block diagram of an optical data communication system, generally designated 100, incorporating an optical data transmission system and including an optical filter, all being constructed according to the principles of the invention. The optical data communication system 100 is configured to receive an input electrical signal representing input data at an electrical input 110. The input data may take the form of digital data, though it could alternatively be analog data.

An amplitude modulation (AM) optical pulse transmitter 120 is coupled to the electrical input to receive the input electrical signal. An optical source (not shown), such as a laser diode, in the AM optical pulse transmitter 120 generates optical (light) pulses at regular intervals (Tᵣₑₚ) amounting to a fixed repetition rate (1/Tᵣₑₚ). In the illustrated embodiment, the fixed repetition rate is between about 500 megahertz (MHz) and about 100 gigahertz (GHz), and the optical pulses are at a wavelength of between about 650 nanometers (nm) and about 1650 nm. In a more specific embodiment, the fixed repetition rate is between about 10 GHz and about 50 GHz, and the optical pulses are at a wavelength of between about 900 nm and about 1400 nm. Those skilled in the pertinent art should understand, however, that the invention encompasses all optical modulation techniques, repetition rates and optical pulse wavelengths.

The optical pulses are modulated in amplitude as a function of the input electrical signal thereby to bear the input data. Were the optical pulse transmitter 120 to employ another modulation technique alone or in combination with AM, the pulses might instead be, e.g., modulated in phase or modulated in both phase and amplitude. The resulting stream of optical pulses is provided along a first optical transmission fiber or optical waveguide 130 that is coupled to the output of the AM optical pulse transmitter 120.

An optical filter 140 is coupled to the AM optical pulse transmitter 120. The specific optical filter 140 of FIG. 1 has a first transmission notch at the inverse of the fixed repetition rate (1/Tᵣₑₚ) and other transmission notches at odd multiples thereof (3/Tᵣₑₚ, 5/Tᵣₑₚ, 7/Tᵣₑₚ, . . . ) and a second transmission notch at the inverse of twice the fixed repetition rate (2/Tᵣₑₚ) and other transmission notches at even multiples thereof (4/Tᵣₑₚ, 6/Tᵣₑₚ, 10/Tᵣₑₚ, . . . ).

The optical filter 140 includes first, second and third 2×2 multimode interferometer (MMIs) 142, 144, 146. A dummy waveguide 141 is coupled to a first input of the first MMI 142. The first optical transmission fiber 130 is coupled to a second input of the first MMI 142.

A first pair of optical paths 143 join first and second outputs of the first MMI 142 to first and second inputs of the second MMI 144. Together, the first MMI 142, the first pair of optical paths 143 and the second MMI 144 constitute a first Mach-Zehnder interferometer. As FIG. 1 schematically indicates, the first pair of optical paths 143 is of different relative length, the upper path as shown being longer than the lower path. The differing lengths create a relative delay between the first pair of optical paths 143. In fact, the relative delay of with respect to the first pair of optical paths 143 is between about ⅓ and ⅔ times the fixed repetition rate and may more specifically be such to create a first transmission notch at the inverse of the fixed repetition rate and other transmission notches at odd multiples thereof.

Likewise, a second pair of optical paths 145 joins first and second outputs of the second MMI 144 to first and second inputs of the third MMI 146. Together, the second MMI 144, the second pair of optical paths 145 and the third MMI 146 constitute a second Mach-Zehnder interferometer. As with the first pair of optical paths 143, the second pair of optical paths 145 is of different relative length, the upper path as shown being longer than the lower path. The differing lengths create a relative delay between the second pair of optical paths 145. In fact, the relative delay of with respect to the second pair of optical paths 145 is between about ⅓ and ¼ times the fixed repetition rate and may more specifically be such to create a second transmission notch at the inverse of twice the fixed repetition rate and other transmission notches at even multiples thereof. The first and second Mach-Zehnder interferometers are in series and therefore form a cascade of Mach-Zehnder interferometers.

A dummy waveguide 147 is coupled to a first output of the third MMI 446. A second optical waveguide 150 is coupled to a second output of the third MMI 446 and may be, for example, an optical fiber. An optical detector 160 is coupled to the second optical waveguide 150. The optical detector 160 is configured to produce an output electrical signal representative of intensities of the optical pulses and may be, for example, a photodetector. The output electrical signal represents output data and is provided at an electrical output 170. Assuming that the optical data communication system 100 is functioning correctly, the output data reflects the input data.

The specific structure of the optical filter 140 is not necessary to the invention. Other conventional or later-developed forms of optical filters could replace the optical filters disclosed herein as long as the notch structures are substantially as described. Further, those skilled in the pertinent art should understand that the optical filter of the invention can be made with conventional planar waveguide structures.

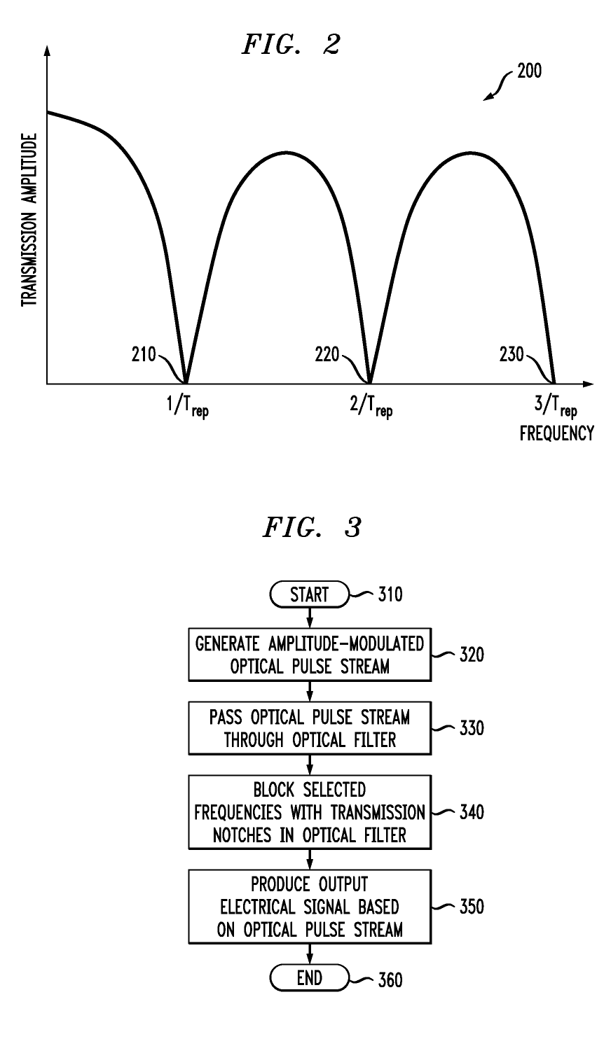

FIG. 2 illustrates a graphical representation of a representative characteristic 200 of one embodiment of an optical filter. The optical filter of FIG. 2 has three transmission notches at 1/Tᵣₑₚ, 2/Tᵣₑₚ, 3/Tᵣₑₚ and odd harmonics thereof, in contrast with the two transmission notches at 1/Tᵣₑₚ, 2/Tᵣₑₚ and odd harmonics thereof of the optical filter 140 of FIG. 1.

Transmission amplitude is plotted against frequency. The optical filter has a first transmission notch 210 at the fixed repetition rate (1/Tᵣₑₚ), a second transmission notch 220 at a first harmonic of the fixed repetition rate (2/Tᵣₑₚ) and a third transmission notch 230 at a second harmonic of the fixed repetition rate (3/Tᵣₑₚ).

FIG. 3 illustrates a flow diagram of one embodiment of a method of communicating data carried out according to the principles of the invention. The method begins in a start step 310. In a step 320, an amplitude-modulated optical pulse stream is generated. The optical pulses in the optical pulse stream are at a fixed repetition rate. In a step 330, the optical pulse stream is passed through an optical filter. In one embodiment, the optical filter has a transmission notch at the fixed repetition rate. In another embodiment, the optical filter also has a transmission notch at a first harmonic of the fixed repetition rate. In yet another embodiment, the optical filter further has a transmission notch at a second harmonic of the fixed repetition rate. In a step 340, one or more transmission notches in the optical filter block one or more selected frequencies in the optical pulse stream. In a step 350, an output electrical signal is produced based on the optical pulse stream. The method ends in a step 360.

Although certain embodiments of the invention have been described in detail, those skilled in the pertinent art should understand that they can make various changes, substitutions and alterations herein without departing from the scope of the invention.

What is claimed is:

1. An optical data communication system, comprising:
an optical pulse transmitter configured to generate optical pulses at a fixed repetition rate;
an optical filter coupled to an output of said optical pulse transmitter, having a transmission notch at said fixed repetition rate and configured to filter said optical pulses; and
an optical detector coupled to an output of said optical filter and configured to produce an output electrical signal representative of intensities of said optical pulses provided by said optical filter.

2. The optical data communication system as recited in claim 1 wherein said optical pulse transmitter is configured to modulate said optical pulses using one of:
amplitude-modulation,
phase modulation, and
both amplitude-modulation and phase-modulation.

3. The optical data communication system as recited in claim 1 wherein said optical filter further has a transmission notch at a first harmonic of said fixed repetition rate.

4. The optical data communication system as recited in claim 1 wherein said optical filter further has a transmission notch at a second harmonic of said fixed repetition rate.

5. The optical data communication system as recited in claim 1 wherein said optical filter includes a cascade of Mach-Zehnder interferometers, each of said Mach-Zehnder interferometers having a relative delay between a pair of optical paths therein.

6. The optical data communication system as recited in claim 5 wherein said relative delay in one of said Mach-Zehnder interferometers is between about ⅓ and ⅔ times said fixed repetition rate, and said relative delay in another of said interferometers is between about ⅓ and ¼ times said fixed repetition rate.

7. The optical data communication system as recited in claim 1 wherein said fixed repetition rate is between about 500 MHz and about 100 GHz and said optical pulses are at a wavelength of between about 650 nm and about 1650 nm.

8. A method of transmitting data, comprising:
generating a stream of optical pulses;
passing said stream of optical pulses through an optical filter, said optical pulses being at a fixed repetition rate, said optical filter having a transmission notch at said fixed repetition rate and a transmission notch at a first harmonic of said fixed repetition rate.

9. The method as recited in claim 8 further comprising further passing said optical filtered stream to an optical detector that produces an output electrical signal representative of intensities of said optical pulses passed through said optical filter.

10. The method as recited in claim 8 wherein said optical are one of:
amplitude-modulated,
phase modulated, and
both amplitude-modulated and phase-modulated.

11. The method as recited in claim 8 wherein said optical filter further has a transmission notch at a second harmonic of said fixed repetition rate.

12. The method as recited in claim 8 wherein said optical filter includes a cascade of Mach-Zehnder interferometers, each of said Mach-Zehnder interferometers having a relative delay between a pair of optical paths therein.

13. The method as recited in claim 12 wherein said relative delay in one of said interferometers is between about ⅓ and ⅔ times said fixed repetition rate, and said relative delay in another of said interferometers is between about ⅓ and ¼ times said fixed repetition rate.

14. The method as recited in claim 8 wherein said fixed repetition rate is between about 500 MHz and about 100 GHz and said optical pulses are at a wavelength of between about 650 nm and about 1650 nm.

15. An optical data transmission system, comprising:
an optical pulse transmitter configured to generate optical pulses at a fixed repetition rate; and
an optical filter coupled to an output of said optical pulse transmitter, having a transmission notch at said fixed repetition rate and configured to filter said optical pulses.

16. The optical data transmission system as recited in claim 15 wherein said optical pulse transmitter is configured to modulate said optical pulses using one of:
amplitude-modulation,
phase modulation, and
both amplitude-modulation and phase-modulation.

17. The optical data transmission system as recited in claim 15 wherein said optical filter further has a transmission notch at a first harmonic of said fixed repetition rate.

18. The optical data transmission system as recited in claim 15 wherein said optical filter further has a transmission notch at a second harmonic of said fixed repetition rate.

19. The optical data transmission system as recited in claim 15 wherein said optical filter includes a cascade of Mach-Zehnder interferometers, each of said Mach-Zehnder interferometers having a relative delay between a pair of optical paths therein.

20. The optical data transmission system as recited in claim 19 wherein said relative delay in one of said Mach-Zehnder interferometers is between about ⅓ and ⅔ times said fixed repetition rate, and said relative delay in another of said interferometers is between about ⅓ and ¼ times said fixed repetition rate.

21. The optical data transmission system as recited in claim 15 wherein said fixed repetition rate is between about 500 MHz and about 100 GHz and said optical pulses are at a wavelength of between about 650 nm and about 1650 nm.
